(19) United States
(12) Patent Application Publication
(10) Pub. No.: US 2024/0092316 A1
(43) Pub. Date: Mar. 21, 2024

(54) CLEANING DEVICE AND ROOF MODULE WITH A CLEANING DEVICE AND MOTOR VEHICLE COMPRISING A ROOF MODULE

(71) Applicant: Webasto SE, Stockdorf (DE)

(72) Inventors: Maximilian EHRMANN, Stockdorf (DE); Andreas MAIER, Stockdorf (DE)

(21) Appl. No.: 18/471,022

(22) Filed: Sep. 20, 2023

(30) Foreign Application Priority Data
Sep. 21, 2022 (DE) 10 2022 124 233.1

(51) Int. Cl. B60S 1/48; B60S 1/56

(52) U.S. Cl. CPC B60S 1/485; B60S 1/56

(57) ABSTRACT

A cleaning device for cleaning a see-through area of an environment sensor of a motor vehicle and for determining an operating-pressure-dependent functional state of at least one cleaning nozzle, the cleaning device having the at least one cleaning nozzle, which is configured to dispense a cleaning fluid. The at least one cleaning nozzle may have a pressure sensor configured to assume at least one position as a function of an operating pressure of the cleaning fluid at the cleaning nozzle and thus determine an operating-pressure-dependent functional state of the at least one cleaning nozzle, in particular as at least one measuring signal.

### CROSS-REFERENCE TO RELATED APPLICATION

This application claims priority from German Patent Application Number 10 2022 124 233.1, filed on Sep. 21, 2022, which is hereby incorporated herein by reference in its entirety for all purposes.

### FIELD

The invention relates to a cleaning device according to the preamble of independent claim 1. Furthermore, the invention relates to a roof module comprising such a cleaning device and/or a motor vehicle comprising at least one roof module and/or at least one cleaning device according to the invention.

### BACKGROUND

Roof modules are used widely used in vehicle manufacturing since these roof modules can be prefabricated as separate functional modules and can be delivered to the assembly line when assembling the vehicle. The roof module at least partially forms a roof skin of the vehicle roof at its outer surface, the roof skin preventing moisture and air flows from entering the vehicle interior. The roof skin is composed of one or more panel components, which can be made of a stable material, such as painted metal or painted or solid-colored plastic. The roof module can be a part of a fixed vehicle roof or a part of an openable roof sub-assembly.

Furthermore, the development in vehicle manufacturing is increasingly focusing on autonomously and semi-autonomously driving motor vehicles. In order to enable the vehicle controller to control the motor vehicle autonomously and/or semi-autonomously, a plurality of environment sensors (e.g., lidar sensors, radar sensors, (multi-)cameras, etc. including other (electrical) components) are employed, which detect the environment surrounding the motor vehicle and determine, for example, a current traffic situation from the acquired environment data. Roof modules which are equipped with a plurality of environment sensors are also known as roof sensor modules (RSM). For this purpose, the known environment sensors send and/or receive suitable electromagnetic signals, such as laser beams or radar beams, allowing a data model of the vehicle environment to be generated by signal evaluation and to be used for controlling the vehicle.

The environment sensors for monitoring and detecting the vehicle environment are typically mounted on the vehicle roof since the vehicle roof is typically the highest point of a vehicle, from where the vehicle environment is easily visible. The environment sensors are typically placed on top of the panel component of the roof module, which forms the roof skin, as attachments; alternatively, they can also be retracted and deployed relative to the panel component. When the environment sensor is in use, ambient conditions (e.g., weather) pose the risk that a partially transparent or transparent see-through area, through which the environment sensor detects the vehicle environment, accumulates dirt and becomes at least partially opaque to the environment sensor. A similar problem is known, for example, for headlight surfaces or windows of a motor vehicle since the headlight surfaces or windows can also accumulate dirt and consequently need to be cleaned.

For cleaning the see-through area or other areas, such as headlight surfaces or windows, the use of a cleaning device is known. By means of the cleaning device, the surfaces in question can be cleaned, usually using a cleaning fluid. Similar to spray nozzles of a windshield or headlight wiper system, the known cleaning devices are usually positioned statically on the outer surface of the roof body in an area of the roof module or the panel component or on other body parts or can be retracted and deployed relative to a body surface. The cleaning nozzles are disposed in front of the surfaces to be cleaned, as viewed in a direction of travel of the motor vehicle, and spray a cleaning fluid onto the area to be cleaned in the direction of the airstream. To prevent the cleaning nozzles from becoming covered in ice and/or snow, which would prevent the cleaning nozzles from functioning properly, it is known for the cleaning nozzles to be heated by means of a typically electrical nozzle heater. This allows ice to be broken up and/or melted and/or snow to be dissolved.

One issue with known cleaning devices is that it is difficult to assess a correct, in particular faultless, functioning of the cleaning nozzles during use in the motor vehicle. If, for example, there is a leak in one of the fluid supply lines and/or at a connection point and/or if a function of a check valve which is used in the cleaning nozzle and by means of which a backflow of the cleaning fluid in a supply line is prevented, or of another component of the cleaning device is faulty and/or disturbed, this can often be determined only by labor-intensive and cost-intensive maintenance of the cleaning device. In this context, it is particularly problematic that only little installation space is available for the cleaning device in particular in the roof area or also in the area of the headlights, which makes the accessibility to the cleaning device more difficult in case of maintenance. If the functioning of the cleaning nozzle is to be checked in other ways, additional components are often necessary, which in turn require additional installation space and further increase the work required for assembly. If, for example, pressure sensors according to a certain industry standard are installed in a cleaning device, this leads to an increase in installation space required since these components are correspondingly large and cost-intensive. All in all, the state of the art does not offer a sufficiently good option for providing a protective shutdown or protective circuit for the cleaning device in case of a possible leak of one of the components of the cleaning device or another malfunction, such as icing and/or a blockage of the cleaning nozzle.

### SUMMARY

Due to the aforementioned disadvantages and problems, one object of the invention is to enhance a generic cleaning device in such a manner that it is optimized in such a manner that a protective shutdown of the cleaning device in the event of a malfunction and/or a determination of a functional state of the cleaning device is/are made possible. In particular, a preferred solution to the object involves activating and/or deactivating a nozzle heater as a function of a functional state of the cleaning device and/or activating and/or deactivating the cleaning device itself.

The object is attained by a cleaning device according to the technical teaching of independent claim 1. Furthermore, the object is attained by a roof module comprising at least one such cleaning device. The object is also attained by a motor vehicle comprising at least one such roof module and/or the at least one cleaning device according to the invention.

Advantageous embodiments of the invention are the subject matter of the dependent claims. Any and all combinations of at least two features disclosed in the description, the claims, and/or the figures fall within the scope of the invention. Naturally, the explanations given in connection with the cleaning device equivalently relate to the roof module and/or the motor vehicle according to the invention without being mentioned redundantly in each context. In particular, linguistically common rephrasing and/or an analogous replacement of respective terms within the scope of common linguistic practice, in particular the use of synonyms backed by the generally recognized linguistic literature, are of course comprised by the content of the disclosure at hand without every variation having to be expressly mentioned.

According to the invention, a cleaning device for cleaning a see-through area of an environment sensor of a motor vehicle and preferably for determining an operating-pressure-dependent functional state of at least one cleaning nozzle is proposed. The cleaning device comprises the at least one cleaning nozzle, which is configured to dispense and/or apply and/or spray a cleaning fluid in particular (on)to a see-through area. Such a see-through area may exemplarily be provided on a motor vehicle and/or on a sensor module having at least one environment sensor and/or on an environment sensor and/or on a sensor housing. The at least one cleaning nozzle comprises a pressure sensor configured to assume at least one position and/or switching position and/or switching situation as a function of an operating pressure of the cleaning fluid at the cleaning nozzle and thus output an operating-pressure-dependent functional state of the at least one cleaning nozzle or, in particular, determine said functional state in the form of at least one measuring signal. The at least one measuring signal can preferably indicate a current functional state of the at least one cleaning nozzle or the cleaning device. This makes it possible to determine the functional state without having to maintain the cleaning device manually. Particularly preferably, such a measuring signal can also be transmitted to an in particular central server of an automobile manufacturer, thus enabling remote maintenance of the cleaning device.

The advantages of the present invention are manifold. In particular, components, in particular pressure sensors according to industrial standards to be additionally placed in the cleaning device, can be dispensed with compared to the state of the art. This reduces the costs for component procurement and assembly. It also reduces the amount of assembly work and subsequent maintenance work. After all, unlike in the state of the art, the pressure sensor is preferably disposed or integrated directly in the cleaning nozzle or at least directly in or on a supply channel in the area of a nozzle head of the cleaning nozzle. This requires only little additional installation space, which has not been the case in the prior art with the use of additional pressure measuring devices. In other words, the cleaning device requires little installation space and can nevertheless provide a particularly extensive diagnostic function regarding a functional state of the at least one cleaning nozzle. In particular, the cleaning device according to the invention can provide a protective circuit, for example in the event of an overpressure load on the cleaning nozzle. In addition, a plurality of functional and/or operating states of the cleaning device can be output by an evaluation of the determined measuring signal, which allows a user and/or a maintenance person to determine whether the cleaning device is operating correctly or malfunctioning. The evaluation of the measuring signal is preferably performed by a controller. Furthermore, the cleaning device according to the invention can be mounted in a simple manner since fewer components are required for determining the functional state compared to the state of the art. In addition, according to the invention, it is possible to calculate a flow rate through the at least one cleaning nozzle by evaluating the operating pressure prevailing at the cleaning nozzle during use. In this way, in particular a consumption of cleaning fluid can be calculated without having to provide a level sensor in a cleaning fluid tank. This means that the cleaning fluid tank can be refilled at an early stage. This saves more resources than continuous level measurement.

Particularly preferably, the pressure gauge is provided on each individual cleaning nozzle, in particular in the area of a respective nozzle head, which means a functional state of each cleaning nozzle can be determined individually. It is thus possible, for example, for an individual cleaning nozzle to be switched off in the event of a malfunction based on the measuring signal, whereas the other cleaning nozzles remain in operation. This can improve the availability of the cleaning device.

Particularly preferably, the pressure sensor acts as a pressure-dependent switch comprising at least two switching positions. One of the switching positions can preferably be a position in which the pressure sensor is in a rest and/or initial position and in which, for example, no operating pressure is applied to the at least one cleaning nozzle. Another of the switching positions can preferably be a position in which the pressure sensor is in an operating pressure position in which, for example, the operating pressure at the cleaning nozzle is in a predetermined working-pressure or operating-pressure range. The pressure sensor can preferably open or close a measuring circuit depending on the position. If the measuring circuit is opened or closed, a measuring signal is generated, in the simplest case in the form of a step response, which corresponds to the position. From the position, in turn, the operating pressure can be inferred. After all, a position assumed by the pressure sensor preferably differs depending on the operating pressure.

This makes it possible in particular to carry out remote maintenance of the cleaning device, in particular on the basis of the measuring signal. A time- and cost-intensive maintenance on site, which is particularly associated with accessibility problems to an installation space of the at least one cleaning device, can preferably be dispensed with or a corresponding maintenance interval can at least be extended.

A contamination and/or a disturbing element which may occur on the see-through area and which is to be removed by the at least one cleaning nozzle may be, for example, dust and/or mud and/or water droplets and/or snow and/or ice and/or biological matter and/or leaves and/or an insect and/or any other contamination.

The phrase “at least one” as used herein means that the cleaning device according to the invention may comprise one or more than one such component.

In a preferred embodiment, the at least one assumed position of the pressure sensor indicates that no operating pressure or a reference operating pressure is applied to the at least one cleaning nozzle, the pressure sensor being configured to generate at least one measuring signal in this at least one position, in particular by opening or closing a measuring circuit, which can indicate the functional state of the at least one cleaning nozzle can be indicated, the functional state being free from operating pressure or reference operating pressure. The expression “free from operating pressure” means that the at least one cleaning nozzle is preferably not subject to an operating pressure of the cleaning fluid in this state, i.e., a pump or a compressor is switched off, for example. A functional state free from operating pressure can be output, for example, when a check valve of the at least one cleaning nozzle is closed, which means no cleaning fluid is present in the area of the nozzle head or the cleaning fluid present is no longer pressurized with respect to an ambient pressure. The term “subject to reference operating pressure” means that the at least one cleaning nozzle is pressurized in this state, for example, with a basic operating pressure, which is preferably required, for example, in order to maintain the cleaning fluid in the channel passages of the cleaning device that lead to the cleaning nozzle. It is understood that the at least one measuring signal may be different measuring signals depending on the functional state, which is why the term is not introduced with a definite article. In particular, multiple measuring signals or only one measuring signal may be generated depending on the functional state when the measuring circuit is opened or closed. Furthermore, it is understood that different measuring circuits may be involved, in particular depending on the position and a functional state measured thereby. For example, it is possible that a different current path in the measuring circuit is closed and/or opened for each position, which means the measuring circuit can also be divided into different sub-circuits.

In a preferred embodiment, the at least one assumed position of the pressure sensor indicates that the operating pressure at the at least one cleaning nozzle deviates from a design operating pressure, the pressure sensor being configured to generate at least one measuring signal in this at least one position, in particular by opening or closing a measuring circuit, which indicates the functional state of the cleaning nozzle deviating from the design operating pressure, in particular malfunctioning. This functional state can be caused, for example, by the fact that a supply line to the cleaning nozzle and/or a connection point between a supply line and another supply line and/or another component of the cleaning nozzle has a leak and/or function of a pump and/or a compressor is not fault-free. Other malfunctions or other misbehavior of the cleaning nozzle is/are also conceivable. Thus, for example, it can be diagnosed whether a pressure loss compared to an operating pressure prevails in a cleaning fluid supply system or whether the at least one cleaning nozzle cannot be operated faultlessly. In particular, it is determined whether a measured pressure deviates from an operating pressure and/or an operating pressure interval. A leak in the cleaning device preferably leads to a pressure reduction compared to an operating pressure and/or an operating pressure interval. If, for example, the pressure falls below a predetermined value, the cleaning device and/or at least a relevant cleaning nozzle can be switched off in response to such a measuring signal.

In a preferred embodiment, the at least one assumed position of the pressure sensor indicates that the operating pressure at the at least one cleaning nozzle is within a design operating pressure range, the pressure sensor being configured to generate at least one measuring signal in this at least one position, in particular by opening or closing a measuring circuit, which can indicate a design operation functional state of the at least one cleaning nozzle. In the design operation functional state, the at least one cleaning nozzle preferably operates faultlessly, i.e., in particular in its optimal or predetermined operating pressure and/or working pressure range. In this state, it can preferably be concluded that all components of the at least one cleaning nozzle are fault-free and fully functional. The output of this measuring signal preferably replaces a manual maintenance of the components of the cleaning device since the worker concerned can read from the measuring signal that the cleaning nozzle is faultless and undamaged and thus no physical maintenance is necessary. In this way, physical maintenance of the cleaning device can preferably be at least partially replaced by virtual and/or non-physical maintenance, i.e., by generating the respective measuring signal. The design operating pressure range preferably indicates a pressure interval around a predetermined design operating pressure including permissible pressure tolerances.

In a preferred embodiment, the at least one assumed position of the pressure sensor indicates that the operating pressure at the at least one cleaning nozzle is in an overpressure range in which the at least one cleaning nozzle is at least partially blocked, in particular by a foreign body and/or a disturbance, and/or in particular pressurized incorrectly, the pressure sensor being configured to generate at least one measuring signal in this at least one position, in particular by opening or closing a measuring circuit, which can indicate an overpressure functional state of the at least one cleaning nozzle. The disturbance may, for example, be ice on a nozzle head of the at least one cleaning nozzle. Alternatively or additionally, the nozzle head may be contaminated and/or blocked by a dirt particle and/or an insect and/or by leaves and/or by mud, such that the cleaning fluid cannot leave the nozzle head unhindered. Alternatively or additionally, it is possible that an operating zone of the cleaning device and/or a single cleaning nozzle is controlled by a pump and/or a compressor and/or a fan in a faulty or incorrect manner. For example, such a pump and/or a compressor and/or a fan may cause faulty pressurization at a pressure above the operating pressure for multiple cleaning nozzles in a common nozzle train, although only one cleaning nozzle is provided in the train. This would also lead to an overpressure load on this one cleaning nozzle; according to the invention, however, this, can be detected by the pressure sensor on the nozzle head in question and prevented in response to the detection. Since a discharge of the cleaning fluid is impeded or prevented by the foreign body or the disturbance, an operating pressure, which is provided by a pump or a compressor and/or by a fan, for example, rises above a predetermined limit value and in particular exceeds an upper limit of the operating pressure range in the direction of the overpressure range. The overpressure may cause damage to components of the cleaning device, which is why such a functional state should be avoided. In response to such a functional state, the cleaning nozzle in question can, for example, be shut off and/or disconnected from a pressurized line system, in particular by closing a corresponding valve. Alternatively or additionally, a countermeasure for removing the foreign body and/or the blockage can be initiated by such a determined functional state. For example, the cleaning nozzle can be heated if it is iced and/or frozen. Alternatively or additionally, in response to the determined functional state in the overpressure range, a pressure surge through the cleaning nozzle can be initiated, in particular in an attempt to expel the foreign body from the nozzle head.

In a preferred embodiment, the at least one cleaning device comprises at least one nozzle heater, which is provided in particular in an area of a nozzle head, for freeing the at least one cleaning nozzle, in particular the nozzle head, from ice and/or snow. The pressure sensor is preferably configured to close a circuit of the nozzle heater when reaching the at least one position or when in the at least one position, thereby preferably activating the nozzle heater to heat the nozzle head. The circuit of the nozzle heater can preferably be the measuring circuit or at least a part of the measuring circuit. For example, the nozzle heater can be connected in parallel to the measuring circuit. By closing the measuring circuit when the position is reached, the parallel circuit of the nozzle heater can preferably be closed, which enables the nozzle heater to heat the cleaning nozzle, for example. In the simplest case, the nozzle heater is a resistor, for example, which generates waste heat because of the current flow. The generated waste heat can be used to heat the at least one cleaning nozzle, in particular in the area of the nozzle head, from which the cleaning fluid emerges.

In a preferred embodiment, the at least one cleaning nozzle comprises at least one nozzle head and/or at least one cleaning fluid supply line and/or at least one check valve in which the pressure sensor is at least partially accommodated or integrated. Particularly preferably, the pressure sensor is disposed or integrated in the area of the nozzle head, preferably in the nozzle head itself or preferably in the cleaning fluid supply line leading directly to the nozzle head.

In a preferred embodiment, the pressure sensor comprises a pressure measuring element, a counter-pressure applicator and a fluid riser duct, in which the pressure measuring element is disposed and/or accommodated in an displaceable manner and configured to be displaced, in particular along an axis of displacement, in particular against a counter-pressure force generated by the counter-pressure applicator, as a function of the operating pressure of the cleaning fluid at the cleaning nozzle so as to assume the at least one position within the fluid riser duct. The fluid riser duct may preferably be comprised in the optional check valve of the cleaning nozzle. In other words, the pressure sensor according to the invention, in combination with a check valve, may be integrated in the at least one cleaning nozzle or at least partially disposed therein. The pressure measuring element can preferably be an actuator that can move within the riser duct, in particular guided by the counter-pressure applicator. The pressure measuring element preferably forms a flow resistance or a pressure resistance to the cleaning fluid flowing into the riser duct in the riser duct, which means the cleaning fluid in the riser duct can move it against the force of the counter-pressure applicator as a function of the prevailing operating pressure. The riser duct preferably comprises a cavity in which the pressure measuring element and/or the counter-pressure applicator is accommodated. The cavity is preferably additionally provided at a reset valve and/or in the nozzle head and/or as a bypass on one of the cleaning fluid supply lines, and the cleaning fluid preferably flows through it continuously on its way to the nozzle head.

In a preferred embodiment, the counter-pressure applicator comprises at least one spring element, in particular a return spring, and/or a magnetic spring element and/or a hydraulic spring element and/or a pneumatic spring element. A counter force to a pressure measuring element displacing force caused by the operating pressure of the cleaning fluid within the riser duct can preferably be generated magnetically and/or electromagnetically and/or mechanically and/or hydraulically and/or pneumatically. For example, the pressure measuring element may be disposed in the end area of a shaft. An opposite end area of the shaft may be received in a coil which can be activated electromagnetically. A current flow in the coil can generate a magnetic force by which the shaft is pressed out of the coil against a fluid resistance. By appropriately calibrating the system to an operating pressure, a pressure measurement can then be made. Of course, similar systems can also be implemented purely magnetically and/or mechanically and/or pneumatically and/or hydraulically. The pressure measuring element preferably reaches the displacement position when there is a force equilibrium between the operating-pressure-dependent, fluid-based pressure measuring element displacement force and the counter-force generated by the counter-pressure applicator. Where along the displacement path within the riser duct this force equilibrium is reached depends in particular on the pressurization of the cleaning fluid.

In a preferred embodiment, the pressure measuring element is configured to open or close an electric circuit when reaching the at least one position and thus generate the at least one measuring signal and preferably, depending on the functional state, cause the cleaning nozzle to be shut off. In said displacement position, the pressure measuring element can, for example, open or close a contact of a transistor and/or another type of switch provided in the area of a wall of the riser duct, whereby in turn the at least one measuring circuit is opened or closed.

In a preferred embodiment, the at least one measuring signal comprises binary measuring information or information on a discrete operating pressure measuring value. In the simplest case, the measuring signal can only output a switching state 1 (switch closed) or a switching state 0 (switch open), i.e., a binary information on the at least one position. When the position is reached, a switch position changes from 0 to 1 or from 1 to 0 in response, for example. The change in the switch position generates, for example, a measuring signal in the form of a step change or a step response of a measuring current. Alternatively, it is possible that the pressure measuring element does not only generate a measuring signal when reaching at least one discrete position. After all, it is also possible that the pressure measuring element continuously generates at least one in particular continuous measuring signal over a predetermined pressure measuring range, in particular as a function of the displacement path of the pressure measuring element along an axis of displacement within the riser duct, preferably starting from an initial position which is in particular free from pressure or subject to reference pressure. This can be done, for example, via a slide resistor or a similar electrical or electro-magnetic component. For example, the pressure measuring element may also change and/or manipulate an impedance of a coil as a function of the at least one displacement position, in particular continuously, and/or change and/or manipulate a capacitance of a capacitor and/or transistor. The electro-technical design is not to be limited here. Particularly preferably, a dependence between the operating pressure at the cleaning nozzle and a current flow caused thereby in the measuring circuit can be reproduced by the measuring signal as a function of a displacement path of the pressure measuring element. The measuring signal is preferably generated continuously or at least at intervals.

The invention further relates to a roof module for forming a vehicle roof on a motor vehicle, the roof module comprising a panel component which at least partially forms a roof skin of the vehicle roof, the roof skin serving as an outer sealing surface of the roof module, at least one environment sensor configured to send and/or receive electromagnetic signals through a see-through area so as to detect a vehicle environment, and at least one cleaning device according to any illustrative example and/or any embodiment of the present invention. Preferably, the roof module may comprise multiple cleaning devices at multiple locations.

In principle, the environment sensor in the present sense may be a lidar sensor and/or a camera sensor and/or a multi-camera sensor and/or an ultrasonic sensor and/or an antenna and/or an antenna module and/or an illumination device. Other environment sensors are also conceivable.

The roof module may comprise the see-through area. Alternatively or complementarily, the at least one environment sensor may comprise a housing or a housing portion on which the see-through area is disposed or integrally formed. The see-through area may be disposed, for example, on a roof module frame of the roof module on which the panel component is preferably disposed and which preferably serves to attach the roof module to a motor vehicle body.

The roof module according to the invention may form a structural unit in which devices for autonomous or semi-autonomous driving supported by driving assistance systems are integrated and which can be mounted as a unit on a vehicle carcass by a vehicle manufacturer. Furthermore, the roof module according to the invention may be a purely fixed roof or a roof including a roof opening system. Furthermore, the roof module may be designed for use in a passenger car or in a commercial vehicle. The roof module can preferably be provided as a structural unit in the form of a roof sensor module (RSM), in which the environment sensors are provided, so as to be inserted into a roof frame of a vehicle body as a suppliable structural unit.

In principle, the environment sensor of the roof module according to the invention can be designed in various ways and comprise a lidar sensor, a radar sensor, an optical sensor, such as a camera, and/or the like. Lidar sensors operate in a wavelength range of 905 nm or about 1550 nm, for example. The material of the see-through area and/or the cover is preferably transparent for the wavelength range used by the environment sensor and therefore preferably selected as a function of the wavelength(s) used by the environment sensor. The see-through area and/or the cover may preferably appear opaque in the wavelengths detectable by the human eye. The cover preferably comprises the same color scheme as the surrounding panel component.

The roof module may in principle be disposed at any location of a motor vehicle and may be designed for different purposes.

The motor vehicle may preferably be a passenger car, a truck, a transport vehicle, a rail vehicle, an autonomously or semi-autonomously driving vehicle, a passenger transport vehicle, a troop vehicle or the like.

The invention further relates to a motor vehicle having at least one roof module and/or a cleaning device according to any embodiment of the present invention. The cleaning device is preferably configured to clean a see-through area of the motor vehicle. The see-through area may be the aforementioned see-through area and/or a see-through area of a headlight or a see-through area of another environment sensor of the motor vehicle, which is in particular not disposed in the roof area and/or in the roof module of the motor vehicle, and/or a window of the motor vehicle, in particular a front and/or rear and/or side window of the motor vehicle. Preferably, the motor vehicle according to the invention comprises a motor vehicle body and is characterized in that the roof module according to the invention forms a structural unit which is disposed on the motor vehicle body, in particular on at least one body rail of the motor vehicle body. The at least one body rail can, for example, be part of a roof frame and/or an A- and/or B- and/or C- and/or D-pillar of the motor vehicle body.

It is understood that the embodiments and illustrative examples mentioned above and yet to be discussed may be realized not only individually but also in any combination with each other without departing from the scope of the present invention. It is also understood that the embodiments and illustrative examples mentioned above and yet to be discussed equivalently or at least similarly relate to all embodiments of the invention without being mentioned separately in each case.

### BRIEF DESCRIPTIONS OF THE DRAWINGS

Embodiments of the invention are schematically illustrated in the drawings and will be discussed by way of example below.

FIG. 1 is a perspective view of a vehicle roof of a motor vehicle with a roof module and a cleaning device;

FIG. 2 is a detailed view of a first embodiment of a cleaning device;

FIG. 3 is another detailed view of the first embodiment of a cleaning device; and

FIG. 4 is a detailed view of a second embodiment of a cleaning device.

### DETAILED DESCRIPTION

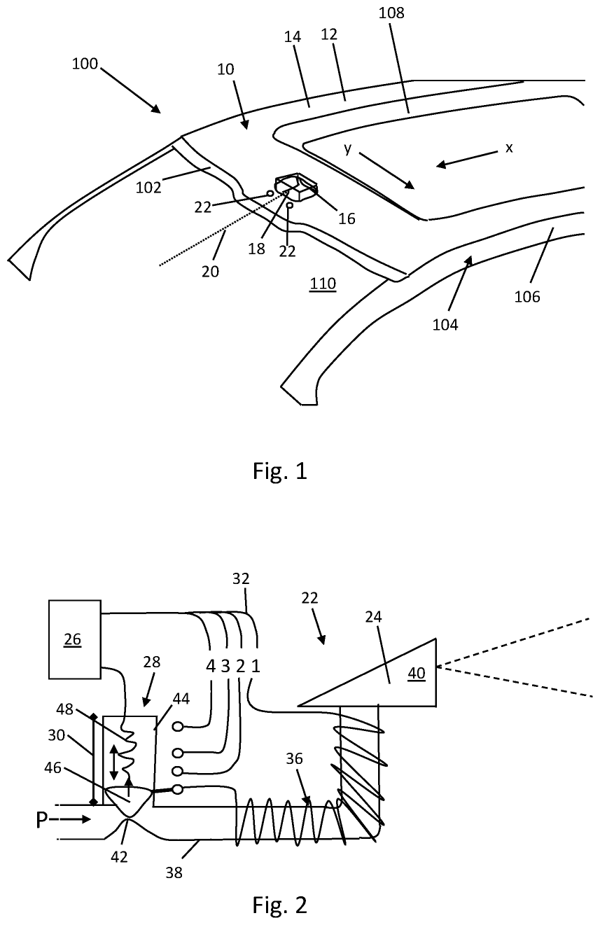

FIG. 1 shows a vehicle roof 100 comprising a roof module 10. The roof module 10 comprises a panel component 12 for forming a roof skin 14 of the vehicle roof 100 of a motor vehicle (not shown in its entirety). In a frontal region of the vehicle roof 100 or the roof module 10, as viewed in a longitudinal vehicle direction x, an environment sensor 16 is disposed symmetrically with respect to the longitudinal vehicle axis x. The environment sensor 16 is disposed directly behind a front transverse rail 102, which defines a roof header of the vehicle. The roof module 10 is preferably disposed on a motor vehicle body 104 as a structural unit. For example, the roof module 10 may be disposed on at least one transverse rail 102 and/or at least one longitudinal rail 106. The roof module 10 in the embodiment shown comprises an optional roof opening system 108. The motor vehicle further comprises a windshield 110.

The environment sensor 16 looks through a see-through area 18 provided, for example, on a housing of the environment sensor 16. The see-through area 18 may, for example, be made of a preferably shatterproof plastic or a material that is transparent or partially transparent to the environment sensor 16 and may be embedded in the housing as a window. The housing can be disposed below the panel component 12 and can be covered by it. Alternatively, the housing can be disposed on one of the body rails 102, 106 or another body component or on a support profile of the roof module 10 rigidly or in such a manner that it can be retracted and deployed relative to the panel component 12.

In the case at hand, the environment sensor 16 is a lidar sensor capable of sending and/or receiving electromagnetic signals through the see-through area 18 so as to detect the vehicle environment. Other types of sensors, such as multidirectional cameras and/or cameras and/or ultrasonic sensors and/or antennas and/or antenna modules and/or illumination devices, may also be used. The environment sensor 16 is aligned along an optical axis 20, which is aligned parallel to the longitudinal vehicle direction x in the case of FIG. 1. The longitudinal vehicle direction x is oriented perpendicularly, in particular orthogonally, to a vehicle width direction y.

The roof module 10 comprises at least one cleaning device 22 having at least one cleaning nozzle 24 and a controller 26. The at least one cleaning nozzle 24 is configured to spray a cleaning fluid onto the see-through area 18 to clean it, e.g., remove a contaminant and/or a disturbance. The at least one cleaning nozzle 24 comprises a pressure sensor 28 configured to assume at least one position 1, 2, 3, 4 along an axis of displacement 30 as a function of an operating pressure of the cleaning fluid applied to the cleaning nozzle 24 and thus determine and/or output an operating-pressure-dependent functional state of the at least one cleaning nozzle 24 in the form of at least one measuring signal. The determination and/or evaluation of the measuring signal determined by the pressure sensor 28 is preferably carried out by the controller 26.

In FIG. 2, the pressure sensor 28 is in position 1. Position 1 of the pressure sensor 28 indicates that no operating pressure or a reference operating pressure is applied to the at least one cleaning nozzle 24. The determination is made by the controller 26. In this at least one position 1, the pressure sensor 28 is configured to generate at least one measuring signal by closing a measuring circuit 32, by which the functional state of the at least one cleaning nozzle 24 is indicated, the functional state being free from operating pressure or subject to reference operating pressure.

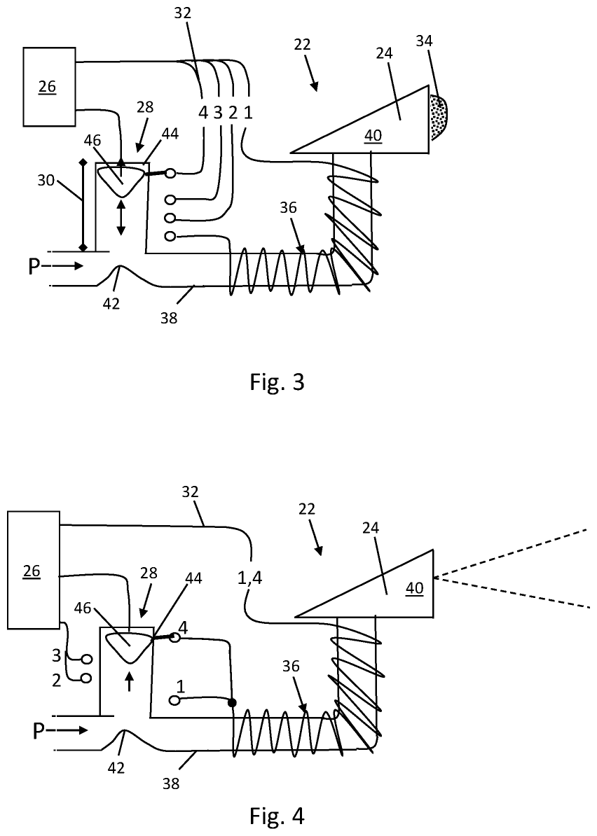

In FIGS. 3 and 4, the pressure sensor 28 is in position 4. Position 4 of the pressure sensor 28 indicates that the operating pressure at the at least one cleaning nozzle 24 is in an overpressure range in which the at least one cleaning nozzle 24 is at least partially blocked by a foreign body and/or a disturbance, in this case ice 34, and/or in particular pressurized in an incorrect manner. The determination is carried out by the controller 26. The pressure sensor 28 is configured to generate at least one measuring signal 4 in this at least one position by closing the measuring circuit 32, which indicates an overpressure functional state of the at least one cleaning nozzle 24. In the case at hand, a different sub-circuit of the measuring circuit 32 is closed in each position reached.

For removing the ice 34, the cleaning device 22 comprises at least one nozzle heater 36. The nozzle heater 36 is formed by a plurality of windings wound around a cleaning fluid supply line 38 in the case at hand. The cleaning fluid supply line 38 is connected to a nozzle head 40 of the cleaning nozzle 24 and supplies cleaning fluid to the nozzle head 40. The nozzle heater 36 is provided in an area of the nozzle head 40 to clear the nozzle head 40 of ice and/or snow or ice 34. The pressure sensor 28 is configured to close a circuit of the nozzle heater 36, in particular the measuring circuit 32 in the case at hand, in the at least one position, according to FIGS. 2 and 4 in positions 1 and 4, and thereby preferably activate the nozzle heater 36. In other words, the nozzle heater 36 can be activated not only when an overpressure situation prevails, see FIG. 4, but also, as can be seen from FIG. 2, in an idle state, in particular in a pressure-free or reference pressure state. In FIG. 4, the circuit of the nozzle heater 36 can be closed when positions 1 or 4 are reached. Other circuits are also conceivable.

For positions 2 and 3, the above explanations apply with suitable modification.

In the case at hand, a check valve 42 is provided in the cleaning fluid supply line 38. The check valve 42 is designed as a one-sided channel constriction on the cleaning fluid supply line 38. A riser duct 44, which is part of the pressure sensor 28, is formed on the check valve 42. A pressure measuring element 46 is accommodated in the riser duct 44 and is displaceable along the axis of displacement 30. A counter-pressure applicator 48 exerts a counter-force, in particular a restoring force, on the pressure measuring element 46. The counter-pressure applicator 48 is a restoring spring in this case. An operating-pressure-related cleaning fluid force exerts a force of the pressure measuring element 46 from one side, said force being oriented in the opposite direction to the restoring force. If the cleaning fluid force is greater than the restoring force, for example, at a high operating pressure, the pressure measuring element 46 is displaced along the axis of displacement 30 within the riser duct 44.

1. A cleaning device for cleaning a see-through area of an environment sensor of a motor vehicle and for determining an operating-pressure-dependent functional state of at least one cleaning nozzle, the cleaning device comprising:
the at least one cleaning nozzle, which is configured to dispense a cleaning fluid, wherein the at least one cleaning nozzle comprises a pressure sensor configured to assume at least one position as a function of an operating pressure of the cleaning fluid at the cleaning nozzle and thus determine an operating-pressure-dependent functional state of the at least one cleaning nozzle as at least one measuring signal.

2. The cleaning device according to claim 1, wherein the at least one assumed position of the pressure sensor indicates that there is no operating pressure or a reference operating pressure at the at least one cleaning nozzle, the pressure sensor being configured to generate at least one measuring signal in this at least one position by opening or closing a measuring circuit, the at least one measuring signal indicating the functional state of the at least one cleaning nozzle, said functional state being free from operating pressure or subject to reference operating pressure.

3. The cleaning device according to claim 1, wherein the at least one assumed position of the pressure sensor indicates that the operating pressure at the at least one cleaning nozzle deviates from an design operating pressure, the pressure sensor being configured to generate at least one measuring signal in this at least one position by opening or closing a measuring circuit, the at least one measuring signal indicating that the functional state of the cleaning nozzle is deviating from the design operating pressure malfunctioning.

4. The cleaning device according to claim 1, wherein the at least one assumed position of the pressure sensor indicates that the operating pressure at the at least one cleaning nozzle is in a design operating pressure range, the pressure sensor being configured to generate at least one measuring signal in this at least one position by opening or closing a measuring circuit, the at least one measuring signal indicating a design operation functional state of the at least one cleaning nozzle.

5. The cleaning device according to claim 1, wherein the at least one assumed position of the pressure sensor indicates that the operating pressure at the at least one cleaning nozzle is in an overpressure range in which the at least one cleaning nozzle is at least partially blocked by a foreign body and/or a disturbance, and/or is pressurized incorrectly, the pressure sensor being configured to generate at least one measuring signal in this at least one position by opening or closing a measuring circuit, the at least one measuring signal indicating an overpressure functional state of the at least one cleaning nozzle.

6. The cleaning device according to claim 1, wherein the cleaning device comprises at least one nozzle heater, which is provided in an area of a nozzle head, for freeing the at least one cleaning nozzle head from ice and/or snow, the pressure sensor being configured to close a circuit of the nozzle heater in the at least one position, thereby activating the nozzle heater.

7. The cleaning device according to claim 1, wherein the at least one cleaning nozzle comprises at least one nozzle head and/or a cleaning fluid supply line and/or a check valve in which the pressure sensor is at least partially accommodated or integrated.

8. The cleaning device according to claim 1, wherein the pressure sensor comprises a pressure measuring element, a counter-pressure applicator and a fluid riser duct in which the pressure measuring element is disposed in a displaceable manner and configured to be displaced against a counter-pressure force generated by the counter-pressure applicator, as a function of the operating pressure of the cleaning fluid at the cleaning nozzle so as to assume the at least one position.

9. The cleaning device according to claim 8, wherein the counter-pressure applicator comprises at least one spring element.

10. The cleaning device according to claim 8, wherein the pressure measuring element is configured to open or close a circuit when reaching the at least one position so as to generate the at least one measuring signal and trigger a shutoff of the cleaning nozzle depending on the functional state.

11. The cleaning device according to claim 1, wherein the at least one measuring signal comprises a binary measuring information or information on a discrete operating pressure measuring value.

12. A roof module for forming a vehicle roof on a motor vehicle, the roof module comprising:
a panel component which at least partially forms a roof skin of the vehicle roof,
the roof skin serving as an outer sealing surface of the roof module, at least one environment sensor configured to send and/or receive electromagnetic signals through a see-through area so as to detect a vehicle environment, and
at least one cleaning device according to claim 1.

13. A motor vehicle comprising:
a roof module for forming a vehicle roof on a motor vehicle, the roof module comprising a panel component which at least partially forms a roof skin of the vehicle roof,
the roof skin serving as an outer sealing surface of the roof module, at least one environment sensor configured to send and/or receive electromagnetic signals through a see-through area so as to detect a vehicle environment, and/or
at least one cleaning device according to claim 1.

14. The motor vehicle according to claim 13, comprising a motor vehicle body, wherein the roof module forms a structural unit disposed on the motor vehicle body.

15. The cleaning device according to claim 9, wherein the at least one spring element is a return spring, and/or a magnetic spring element and/or a hydraulic spring element and/or a pneumatic spring element.

16. The motor vehicle according to claim 14, wherein the structural unit disposed on the motor vehicle body is an at least one body rail of the motor vehicle body.
